(19) United States
(12) Patent Application Publication
(10) Pub. No.: US 2010/0029237 A1
(43) Pub. Date: Feb. 4, 2010

(54) Radio receiving apparatus and radio receiving method

(75) Inventors: Yuji Yamamoto, Kanagawa (JP); Osamu Hosyuyama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: NEC ELECTRONICS CORPORATION, Kawasaki (JP); NEC CORPORATION, Tokyo (JP)

(21) Appl. No.: 12/461,010

(22) Filed: Jul. 29, 2009

(30) Foreign Application Priority Data
Aug. 4, 2008 (JP) 2008-200593

(51) Int. Cl. H04B 1/10

(52) U.S. Cl. 455/296

(57) ABSTRACT

A radio receiving apparatus includes a detection unit and a directivity changing unit. The detection unit detects an occurrence of intermodulation interference to a desired signal demodulated based on received signals received by a plurality of antenna elements. The directivity changing unit changes a reception directivity pattern of the plurality of antenna elements to another pattern having a null direction different from a null direction obtained before the directivity pattern is changed, in accordance with detection of the occurrence of the intermodulation interference by the detection unit.

### BACKGROUND OF THE INVENTION

1. Field of the Invention

The present invention relates to a radio receiving apparatus that receives a radio signal such as a frequency modulation signal (hereinafter referred to as “FM signal”). In particular, the present invention relates to a radio receiving apparatus capable of adaptively controlling the reception directivity of receiving antennas.

2. Description of Related Art

Intermodulation interference is known as an interference phenomenon that may occur in radio receiving apparatuses. The intermodulation interference is hereinafter referred to as “IM interference”. The IM interference occurs when the frequency of a third-order intermodulation signal (IM3) generated due to the nonlinearity of an amplifier or the like included in a radio receiving apparatus is close to a frequency of a desired signal. Specifically, assuming that frequencies of two signals which are different from the desired signal are set as f1 and f2, frequencies f31 and f32 of the third-order intermodulation signals are expressed by Formulae (1) and (2) shown below. When the frequency f31 or f32 is close to a frequency f0 of the desired signal, the IM interference to the desired signal occurs.

f31=2×f1−f2 (1)

f32=2×f2−f1 (2)

Japanese Unexamined Patent Application Publication No. 5-327571 discloses a radio receiving apparatus which includes two analog front-ends (AFEs) having different reception sensitivities, and which is capable of switching the AFE to be used between two AFEs in accordance with the detection of an occurrence of the IM interference. More specifically, the radio receiving apparatus disclosed in JP 5-327571 A has a function of switching between a first AFE having a low reception sensitivity and a second AFE having a high reception sensitivity, and also has a function of detecting the occurrence of the IM interference. Upon detection of the occurrence of the IM interference during demodulation processing for the desired signal using an output of the second AFE, the radio receiving apparatus performs an operation of switching the AFE, which supplies a received signal to a demodulation unit, to the first AFE. The first AFE having the low reception sensitivity is set so as to cause an AGC (Automatic Gain Control) to operate more rapidly, compared to the second AFE. This leads to suppression of a gain at low level compared to the second AFE, while the occurrence of the intermodulation signal can be suppressed compared to the second AFE.

Japanese Unexamined Patent Application Publication Nos. 8-237180, 7-86972, 11-284530, 2000-252899, 10-209890, and 2003-110476 disclose radio receiving apparatuses each having an adaptive array antenna capable of changing the reception directivity. Among them, the radio receiving apparatuses disclosed in JP 8-237180 A and JP 7-86972 A perform adaptive equalization processing individually on each radio signal received by a plurality of antennas, and then adaptively combine the signals. As a result, waveform distortion due to multipath interference (frequency selective fading) is effectively removed.

JP 11-284530 A discloses a radio receiving apparatus capable of discontinuously switching weighting factors for use in generating a composite signal by combining received signals received by a plurality of antenna elements, according to the time when an interference signal is mixed into a desired signal. More specifically, the radio receiving apparatus disclosed in JP 11-284530 A includes first and second weighting factor calculation units, a reception quality measurement unit, and a weighting factor switching unit. The first weighting factor calculation unit calculates weighting factors by comparing a received signal of each antenna with a known signal in order to eliminate a synchronous interference signal which is synchronized with the desired signal. The second weighting factor calculation unit repeatedly calculates weighting factors by executing an adaptive algorithm for minimizing an error between a composite signal and a reference signal in order to eliminate an asynchronous interference signal which is asynchronous to the desired signal. The reception quality measurement unit measures the reception quality of the composite signal. The weighting factor switching unit switches a supply source of weighting factors used for generating the composite signal, from the first weighting factor calculation unit to the second weighting factor calculation unit, in accordance with the change of the reception quality of the composite signal. Note that JP 11-284530 A fails to disclose a specific example of the reception quality measured by the reception quality measurement unit.

JP 2000-252899 A discloses a radio receiving apparatus which is capable of changing a directivity pattern of an adaptive array antenna and which is used to be mounted on a vehicle. The radio receiving apparatus disclosed in JP 2000-252899 A is capable of selecting a given directivity pattern from four directivity patterns of, for example, forward, backward, rightward, and leftward of a vehicle. Further, JP 2000-252899 A discloses a received signal intensity of an intermediate frequency signal (IF signal) as a specific example for detecting the sound quality of an audio signal.

JP 10-209890 A discloses a radio receiving apparatus capable of switching between selection diversity reception and weighting and combining reception using an adaptive algorithm, depending on the quality of the signal. The term “selection diversity reception” herein described refers to a reception method for selecting one of a plurality of signals received by a plurality of reception antennas in accordance with a predetermined diversity determination criterion. Meanwhile, the term “weighting and combining reception” herein described refers to a reception method for calculating weighting factors for signals received by a plurality of reception antennas by use of an adaptive algorithm such as CMA (Constant Modulus Algorithm) to combine the signals received by the plurality of reception antennas by using the weighting factors. Further, JP 10-209890 A discloses an average electrical power for a diversity signal selected by the selection diversity reception and an average electrical power for a composite signal received by the weighting and combining reception, as specific examples of the signal quality based on which the reception method is switched.

### SUMMARY

As described above, the radio receiving apparatus disclosed in JP 5-327571 A switches the AFE to the first AFE having a characteristic that gives priority to the suppression of the IM interference, when the IM interference is detected in the output signal of the second AFE having a characteristic that gives priority to the improvement of the reception sensitivity. In other words, the radio receiving apparatus disclosed in JP 5-327571 A is configured to reduce the gain of an amplifier in the AFE under the reception conditions in which the IM interference occurs, and the reception sensitivity of the desired signal is suppressed under the state in which the IM interference is occurring. Accordingly, it is difficult for the radio receiving apparatus disclosed in JP 5-327571 A to avoid the deterioration of the reception sensitivity of the desired signal under the reception conditions in which the IM interference is occurring.

Meanwhile, the radio receiving apparatus disclosed in JP 8-237180 A is capable of adjusting the reception directivity by adaptively combining signals received by two antenna elements. Accordingly, the radio receiving apparatus disclosed in JP 8-237180 A adaptively adjusts the directivity to form a null point in an arrival direction of an interfering signal, thereby making it possible to attenuate the interfering signal. By application of the adaptive combining technique disclosed in JP 8-237180 A, an adaptive operation can be achieved in principal so that a null point is formed in the arrival direction of the interfering signal that causes the IM interference. However, even when the reception directivity is adjusted in accordance with a known adaptive algorithm, the reception level of the desired signal may be attenuated, which may lead to an inappropriate operation of actively receiving interfering signals. This is because, in the case of adjusting the reception directivity using a known adaptive algorithm, when the signal intensity of each of two interfering signals which cause the IM interference is higher than the signal intensity of the desired signal, a null point may be formed in the arrival direction of the desired signal, and it is difficult to recover from the state where the local directivity is adjusted.

JP 7-86972 A, JP 11-284530 A, JP 2000-252899 A, JP 10-209890 A, and JP 2003-110476 A fail to disclose a technique of adjusting the reception directivity in accordance with the occurrence of the IM interference.

In other words, the radio receiving apparatuses of the related art have a problem that it is difficult to avoid the deterioration of the reception sensitivity of the desired signal and to suppress the IM interference at the same time, under the reception conditions in which the reception intensity of the desired signal is lower than the reception intensity of the interfering signal.

In order to solve the above-mentioned problem, a first exemplary aspect of the present invention is a radio receiving apparatus including a detection unit and a directivity changing unit. The detection unit detects an occurrence of intermodulation interference to a desired signal. The desired signal is demodulated based on received signals received by a plurality of antenna elements. The directivity changing unit changes a reception directivity pattern of the plurality of antenna elements to another pattern having a null direction different from a null direction obtained before the directivity pattern is changed, in accordance with detection of the occurrence of the intermodulation interference by the detection unit.

Note that the directivity changing unit corresponds to, for example, a coefficient updating unit 14 according to a first exemplary embodiment of the present invention to be described later. The coefficient updating unit 14 generates tap coefficients using direct coefficient values determined independently of the adaptive algorithm, in accordance with the detection of the occurrence of the IM interference, and supplies the tap coefficients to digital filters 13A and 13B. The directivity changing unit corresponds to each of an adder 31, a subtractor 32, and a switch 33 according to a third exemplary embodiment of the present invention to be described later. Furthermore, the directivity changing unit corresponds to an adder 41, a subtractor 42, and a switch 43 according to a fourth exemplary embodiment of the present invention to be described later.

As described above, the radio receiving apparatus according to the first exemplary aspect of the present invention changes a directivity pattern of the plurality of antenna elements to another pattern having a null direction different from a null direction obtained before the directivity pattern is changed, in accordance with detection of the occurrence of the IM interference. Thus, the null point is more easily formed in an arrival direction of an interfering signal that causes the IM interference. In other words, the radio receiving apparatus according to the first exemplary aspect of the present invention is capable of reducing the reception of signals from the arrival direction of the interfering signal that causes the IM interference, and effectively suppressing the occurrence of the IM interference.

Further, the radio receiving apparatus according to the first exemplary aspect of the present invention does not necessarily require an operation for suppressing the IM interference as disclosed in JP 05-327571 A, namely, suppression of a gain of a reception amplifier for directly suppressing the occurrence of the intermodulation signal. Thus, the deterioration of the reception sensitivity of the desired signal can be avoided, unlike the technique disclosed in JP 5-327571 A.

Furthermore, the radio receiving apparatus according to the first exemplary aspect of the present invention forcibly changes a null direction of the reception directivity when the IM interference occurs. For this reason, the radio receiving apparatus can avoid an appropriate operation in which the null point is formed in the arrival direction of the desired signal, when the reception directivity is adjusted using the adaptive algorithm. In other words, the radio receiving apparatus can avoid the deterioration of the reception sensitivity of the desired signal and suppress the IM interference at the same time, even under the reception conditions in which the reception intensity of the desired signal is lower than the reception intensity of the interfering signal.

A second exemplary aspect of the present invention is a radio receiving apparatus including an analog signal processing unit, an A/D conversion unit, a plurality of digital filters, a signal combining unit, and a coefficient updating unit. The analog signal processing unit performs analog signal processing on received signals received by a plurality of antenna elements. The A/D conversion unit generates digital signals by sampling the received signals subjected to the analog signal processing. The plurality of digital filters is capable of adjusting amplitudes and phases of the digital signals. The signal combining unit generates a composite signal by combining the digital signals subjected to filter processing by the plurality of digital filters. The coefficient updating unit updates tap coefficients of the plurality of digital filters in accordance with an adaptive algorithm. Furthermore, the coefficient updating unit performs exceptional updating of at least one of the tap coefficients independently of the adaptive algorithm, in accordance with detection of an occurrence of intermodulation interference to a desired signal demodulated based on the composite signal.

As described above, the radio receiving apparatus according to the second exemplary aspect of the present invention is capable of updating processing for the tap coefficients based on the adaptive algorithm and performing exceptional updating of at least one of the tap coefficients in accordance with the detection of the occurrence of the IM interference. Thus, when the IM interference occurs, the tap coefficients can be forcibly updated so that the null direction of the reception directivity is changed, independently of the adaptive algorithm.

According to the exemplary aspects of the present invention, it is possible to provide a radio receiving apparatus capable of avoiding the deterioration of the reception sensitivity of the desired signal as well as suppressing the IM interference, even under the reception conditions in which the reception intensity of the desired signal is lower than the reception intensity of the interfering signal.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a radio receiving apparatus according to a first exemplary embodiment of the present invention;

FIGS. 2A to 2D are diagrams each showing an example of a reception directivity pattern of the radio receiving apparatus according to the first exemplary embodiment of the present invention;

FIG. 3 is a block diagram showing a configuration example of a coefficient updating unit included in the radio receiving apparatus shown in FIG. 1;

FIG. 4 is a block diagram showing a configuration example of an IM interference detecting unit included in the radio receiving apparatus shown in FIG. 1;

FIG. 5 is a block diagram showing a radio receiving apparatus according to a second exemplary embodiment of the present invention;

FIG. 6 is a block diagram showing a configuration example of a quality determining unit included in the radio receiving apparatus shown in FIG. 5;

FIG. 7 is a block diagram showing a radio receiving apparatus according to a third exemplary embodiment of the present invention;

FIGS. 8A and 8B are diagrams each showing an example of a reception directivity pattern of the radio receiving apparatus according to the third exemplary embodiment;

FIG. 9 is a block diagram showing a radio receiving apparatus according to a fourth exemplary embodiment of the present invention;

FIG. 10 is a block diagram showing a radio receiving apparatus according to a fifth exemplary embodiment of the present invention; and

FIG. 11 is a block diagram showing an AFE included in the radio receiving apparatus shown in FIG. 10.

### DETAILED DESCRIPTION OF THE EXEMPLARY EMBODIMENTS

Exemplary embodiments of the present invention will be described in detail below with reference to the accompanying drawings. The same components are denoted by the same reference symbols throughout the drawings, and a redundant description is omitted as appropriate for clarification of the explanation.

### First Exemplary Embodiment

A radio receiving apparatus 1 according to a first exemplary embodiment of the present invention adjusts amplitudes and phases of received signals received by a plurality of antenna elements, and then combines the received signals. The radio receiving apparatus 1 changes the adjustment amount of the amplitudes and phases of the received signals, to thereby make it possible to change the reception directivity of the plurality of antenna elements.

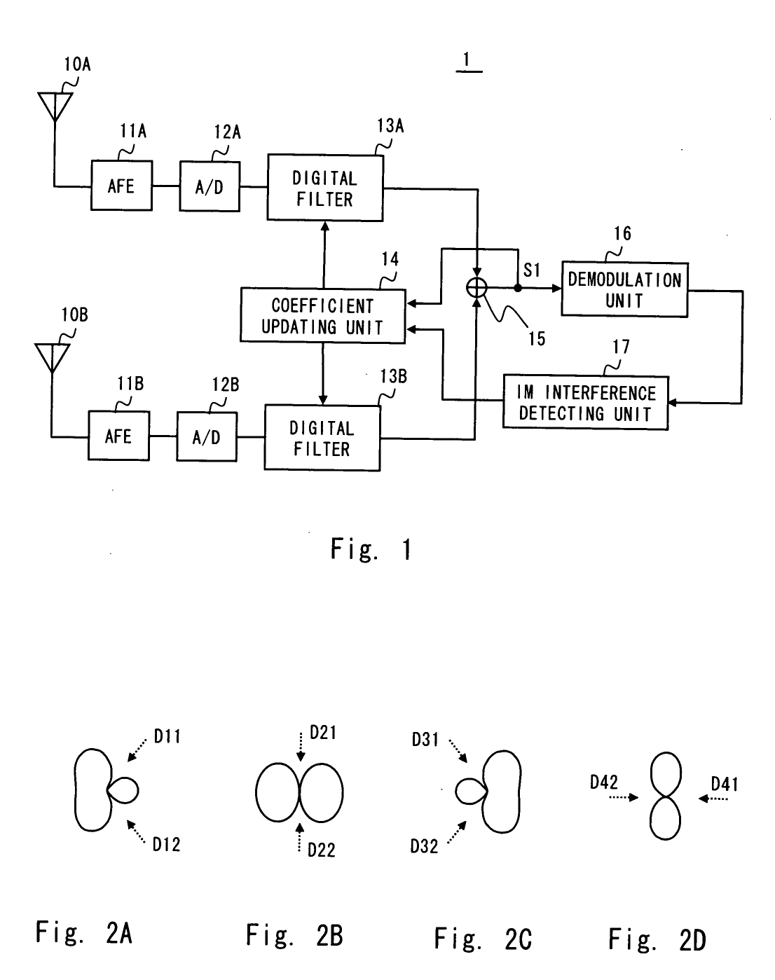

FIG. 1 is a block diagram showing a configuration example of the radio receiving apparatus 1. Components of the radio receiving apparatus 1 shown in FIG. 1 are described below. Antenna elements 10A and 10B each receive a radio signal. An analog front-end (AFE) 11A performs analog signal processing including band limitation of the radio signal received by the antenna element 10A, conversion of the radio signal into an intermediate frequency signal (IF signal), and amplification of the IF signal. An AFE 11B performs analog signal processing similar to that of the AFE 11A on the radio signal received by the antenna element 10B.

An A/D converter 12A performs digital sampling of the analog IF signal supplied from the AFE 11A to generate a digital IF signal. Likewise, an A/D converter 12B converts the analog IF signal supplied from the AFE 11B into a digital IF signal.

The digital IF signal generated by the A/D converter 12A is sent to a digital filter 13A. The digital filter 13A serves as a transversal digital filter, and carries out filter processing on the digital IF signal by using tap coefficients supplied from a coefficient updating unit 14 described later. Likewise, a digital filter 13B carries out filter processing on the digital IF signal generated by the A/D converter 12B.

The coefficient updating unit 14 executes adaptive algorithms such as LMS (Least Mean Square), NMLS (Normalized MLS), and CMA in order to optimize tap coefficients of the digital filters 13A and 13B. Then, the coefficient updating unit 14 repeatedly generates updated tap coefficients and supplies the generated tap coefficients to the digital filters 13A and 13B. Further, the coefficient updating unit 14 is capable of updating the tap coefficients independently of the adaptive algorithms, in response to a control signal supplied from an IM interference detecting unit 17 described later. Specific operations and a configuration example of the coefficient updating unit 14 will be described later.

An adder 15 adds digital IF signals of two channels that have been subjected to the filter processing with the filter 13A and 13B, and generates a composite signal S1 to be subjected to digital demodulation processing.

A demodulation unit 16 carries out digital demodulation processing for demodulating a desired signal from the composite signal S1. The demodulated signal is supplied to a signal processing unit (not shown) that is provided at a subsequent stage, and is supplied to the IM interference detecting unit 17.

The IM interference detecting unit 17 receives the demodulated signal to detect the occurrence of the IM interference to the desired signal. Upon detection of the occurrence of the IM interference, the IM interference detecting unit 17 outputs a control signal to the coefficient updating unit 14. Specific operations and a configuration example of the IM interference detecting unit 17 will be described later.

Next, specific operations of the coefficient updating unit 14 are described below. The coefficient updating unit 14 performs processing for updating the tap coefficients of the digital filters 13A and 13B in accordance with the adaptive algorithm by using the composite signal S1 generated by the adder 15. The processing for updating the tap coefficients in accordance with the adaptive algorithm allows the digital filters 13A and 13B to operate so that the reception directivity is oriented in an arrival direction of a desired signal and that a null point is formed in an arrival direction of an interfering signal. Note that the tap coefficients may be updated using delay values of the digital filters 13A and 13B. The adaptive algorithm applied to the coefficient updating unit 14 is not particularly limited, and the coefficient updating unit 14 may utilize known adaptive algorithms such as the LMS algorithm and CMA.

Further, upon receiving the control signal indicating the detection of the occurrence of the IM interference from the IM interference detecting unit 17, the coefficient updating unit 14 operates so that the tap coefficients are forcibly rewritten independently of the adaptive algorithm. In this case, the tap coefficients thus rewritten are selected so that a null direction of the reception directivity is set in a direction different from a null direction obtained before the tap coefficients are overwritten.

An example of reception directivity pattern change is described below. For ease of explanation, it is assumed that an initial center tap position of each of the digital filters 13A and 13B is located at the Nth position and that the distance between the antenna elements 10A and 10B corresponds to a half wavelength of the carrier frequency of the radio signal. The coefficient updating unit 14 may periodically change the center tap position of each of the digital filters 13A and 13B to any one of Combinations 1 to 4 mentioned below, every time the IM interference is detected.
[Combination 1] filter 13A: Nth position; and filter 13B: (N+1)th position
[Combination 2] filter 13A: Nth position; and filter 13B: (N+2)th position
[Combination 3] filter 13A: (N-1)th position; and filter 13B: Nth position
[Combination 4] filter 13A: Nth position; and filter 13B: Nth position

FIGS. 2A to 2D respectively show directivity patterns obtained by Combinations 1 to 4 of center tap positions. Dotted arrows D11, D12, D21, D22, and the like shown in FIGS. 2A to 2D each indicates a null direction of the directivity patterns. Note that the relationship between a center tap position and a directivity pattern varies depending on a unit delay value (i.e., sampling frequency) of each of the digital filters 13A and 13B. A detailed description thereof will be omitted, since this is a matter of design that can be easily made by those skilled in the art.

The above-mentioned directivity pattern change is described by way of example only. Alternatively, for example, the order of change of Combinations 1 to 4 may be arbitrarily selected. Further, in order to moderate a change in directivity, a change in phase between patterns may be reduced assuming that the total number of directivity patterns having different null directions is greater than or equal to 5. In this case, the center tap position of the digital filter 13B in “Combination 2” described above may be represented by (N+1)+(N+2), for example. Alternatively, the total number of directivity patterns having different null directions may be 2 or 3. More alternatively, the directivity patterns may be changed randomly.

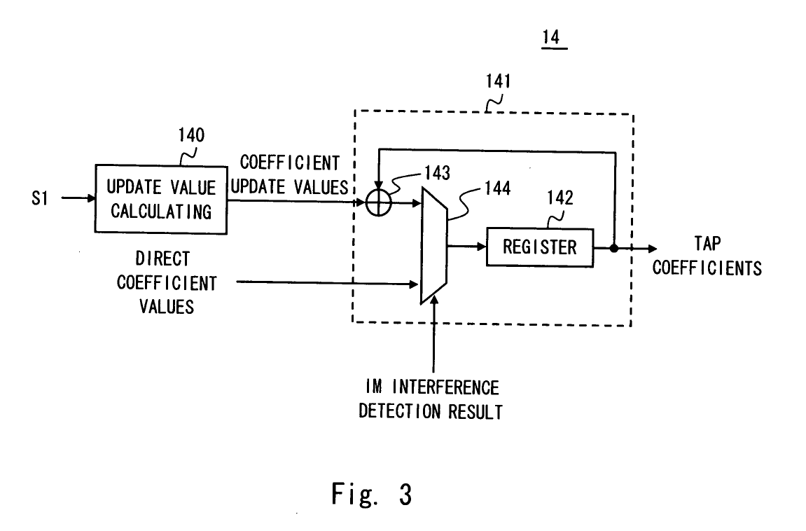

Next, a specific configuration example of the coefficient updating unit 14 will be described. FIG. 3 is a block diagram showing a configuration example of the coefficient updating unit 14. In the example shown in FIG. 3, the coefficient updating unit 14 includes an update value calculating unit 140 and an accumulator 141. The update value calculating unit 140 calculates coefficient update values in accordance with the adaptive algorithm.

The accumulator 141 includes a register 142 that holds the tap coefficients supplied to the digital filters 13A and 13B. An adder 143 adds the values held in the register 142 and the coefficient update values, and updates the values of the register 142 based on the addition results.

A selector 144 operates based on the control signal from the IM interference detecting unit 17, namely, based on the results of the detection of the IM interference. Specifically, when the occurrence of the IM interference is not detected, the selector 144 supplies the signal from the adder 143 to the register 142. Meanwhile, when the occurrence of the IM interference is detected, the selector 144 supplies direct coefficient values to the register 142. The term “direct coefficient values” herein described refers to tap coefficients that are selected so that the null direction is changed independently of the adaptive algorithm. For example, in the above-described example of directivity pattern change, the direct coefficient values are periodically selected from among Combinations 1 to 4.

Next, a description is given of the principle of detecting the IM interference in the IM interference detecting unit 17 and a configuration example of the IM interference detecting unit 17. The IM interference detecting unit 17 may measure the modulation index of the desired signal contained in the demodulated signal to detect the occurrence of the IM interference by using the measurement results. As described above, the IM interference occurs due to a third-order intermodulation signal (IM3) of two interfering signals. As expressed by Formulae (1) and (2), a third-order intermodulation signal is generated from a second harmonic component of one of the interfering signals (e.g., f1) and a fundamental wave component of the other of the interfering signals (e.g., f2). Accordingly, the modulation index of the third-order intermodulation signal is twice as large as the modulation index of the original interfering signal f1. Thus, when the frequency band of the third-order intermodulation signal overlaps the frequency band of the desired signal to cause the IM interference, the modulation index of the desired signal contained in the demodulated signal seems to be larger than the original value. In other words, the IM interference detecting unit 17 measures the magnitude of the modulation index of the desired signal contained in the demodulated signal, thereby enabling detection of the IM interference.

When the radio receiving apparatus 1 serves as an FM broadcast receiver, for example, the radio receiving apparatus 1 may measure the modulation index of at least one of a main audio signal (L+R signal), a sub-audio signal (L−R signal), a pilot signal, and other multiple signals (e.g., an RDS (Radio Data System) signal, and a VICS (Vehicle Information and Communication System) signal) which are contained in the demodulated signal.

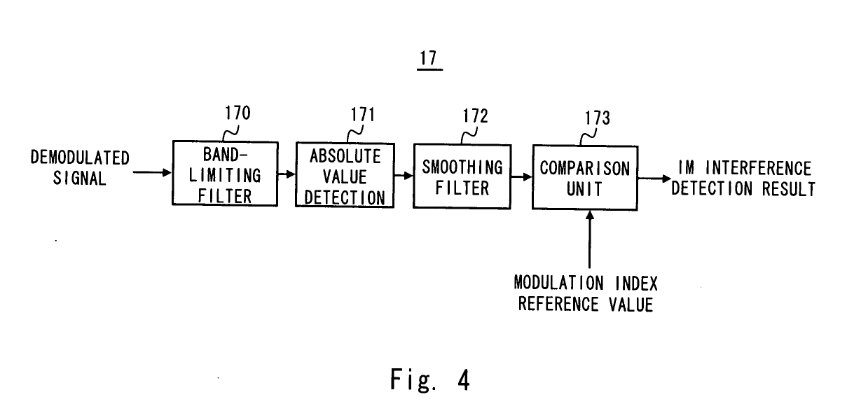

FIG. 4 is a block diagram showing a configuration example of the IM interference detecting unit 17 for detecting the IM interference based on the modulation index. Referring to FIG. 4, a band-limiting filter 170 receives the demodulated signal from the demodulation unit 16 to carry out band-limiting processing. An absolute value detecting unit 171 detects an absolute value of an output signal of the band-limiting filter 170 to extract a modulation index value. The output of the absolute value detecting unit 171 may contain an unnecessary harmonic component, and thus a smoothing filter 172 removes the unnecessary harmonic component. A comparison unit 173 compares the modulation index value appearing at the output of the smoothing filter 172 with a predetermined reference value of the modulation index. Note that the reference value of the modulation index may be appropriately set depending on the use area and service contents of the radio receiving apparatus 1. When a modulation index exceeding the reference value is measured, the comparison unit 173 transmits a control signal indicating the occurrence of the IM interference, to the coefficient updating unit 14.

As described above, upon detection of the occurrence of the IM interference, the radio receiving apparatus 1 according to this exemplary embodiment performs exceptional updating of at least one of the tap coefficients supplied to the digital filters 13A and 13B, independently of the adaptive algorithm. In other words, upon detection of the occurrence of the IM interference, the radio receiving apparatus 1 can change the reception directivity pattern of the antenna elements 10A and 10B to another pattern having a null direction different from that obtained before the change. As a result, the null point can be easily formed in an arrival direction of an interfering signal that causes the IM interference. Therefore, the radio receiving apparatus 1 can reduce the reception of signals from the arrival direction of the interfering signal that causes the IM interference, and effectively suppress the occurrence of the IM interference.

### Second Exemplary Embodiment

A radio receiving apparatus 2 according to a second exemplary embodiment of the present invention changes the reception directivity pattern of the antenna elements 10A and 10B so that the null direction is changed according to a detection of the occurrence of the IM interference as well as a judgment result of the quality of the demodulated signal.

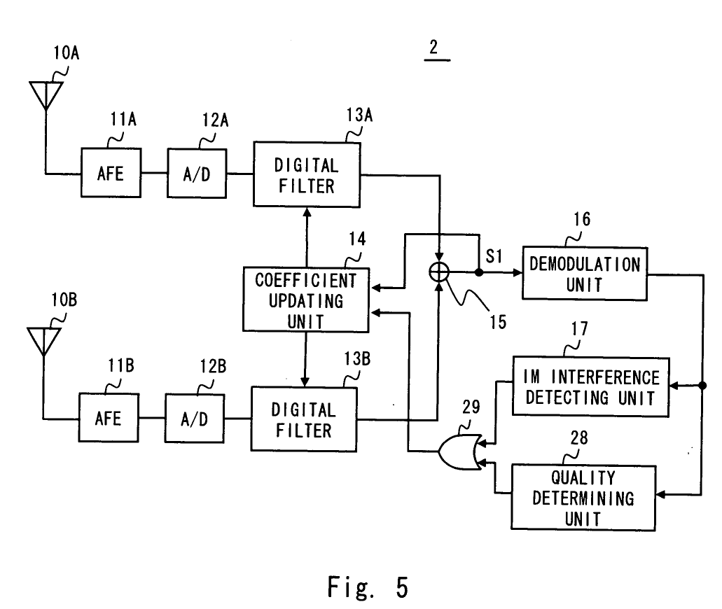

FIG. 5 is a block diagram showing the radio receiving apparatus 2. A quality determining unit 28 shown in FIG. 5 determines how many components, which cause the reception quality to be lowered, are contained in the demodulated signal. Upon detection of the degradation of the reception quality such as the degradation of an S/N ratio, the quality determining unit 28 outputs a control signal to the coefficient updating unit 14 in a similar manner as the IM interference detecting unit 17.

The control signal output from the IM interference detecting unit 17 or the quality determining unit 28 is fed to the coefficient updating unit 14 through an OR circuit 29. Specifically, the coefficient updating unit 14 of this exemplary embodiment changes the reception directivity pattern of the antenna elements 10A and 10B according to at least one of the conditions, namely, at least one of the occurrence of the IM interference and the degradation in quality of the demodulated signal. As described in the first exemplary embodiment, the reception directivity pattern is changed so that the null point is formed in a direction different from that obtained before the change.

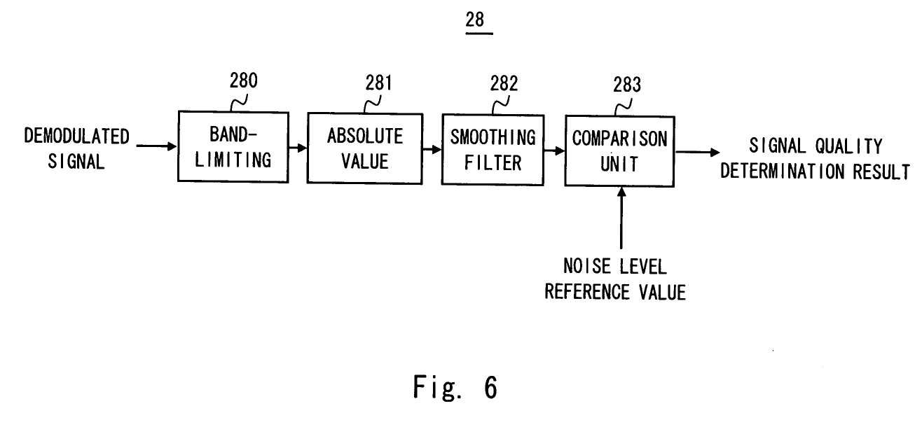

Next, a specific configuration example of the quality determining unit 28 will be described. FIG. 6 is a block diagram showing a configuration example of the quality determining unit 28. Referring to FIG. 6, a band-limiting filter 280 receives the demodulated signal from the demodulation unit 16 to carry out band-limiting processing. An absolute value detecting unit 281 detects an absolute value of an output signal of the band-limiting filter 280 to extract a noise component and a harmonic component that are contained in the demodulated signal. Information obtained by the absolute value detection contains an unnecessary harmonic component, and thus a smoothing filter 282 removes the unnecessary harmonic component. A comparison unit 283 compares a noise component value appearing at the output of the smoothing filter 282 with a predetermined reference value of the noise component. Note that the reference value of the noise component may be appropriately set depending on the use area and service contents of the radio receiving apparatus 2. When a noise component exceeding the reference value is measured, the comparison unit 283 transmits a control signal indicating the degradation in quality of the modulated signal, to the coefficient updating unit 14.

An advantage of providing the quality determining unit 28 in combination with the IM interference detecting unit 17 is described below. In general, the arrival direction of the desired signal is not limited to one direction. Accordingly, even when the reception directivity pattern is changed in accordance with the detection of the IM interference, it is unlikely that the desired signal cannot be received. However, the arrival direction of the desired signal may be close to the arrival direction of the interfering signal that causes the IM interference, though it is a rare case. In this case, there is a possibility that the desired signal may be attenuated at the time when the interference signal is attenuated. When the desired signal is attenuated due to the change of the directivity pattern, the S/N ratio of the demodulated signal deteriorates. The quality determining unit 28 of this exemplary embodiment determines that the quality of the demodulated signal has deteriorated due to the change of the directivity pattern. Thus, upon determination of the degradation, the quality determination unit 28 can change the directivity pattern again. In other words, if the quality determining unit 28 is provided, the radio receiving apparatus 2 can be rapidly recovered from the state where the quality of the demodulated signal has deteriorated due to the change of the directivity pattern, resulting in avoidance of the attenuation of the desired signal.

### Third Exemplary Embodiment

A radio receiving apparatus 3 according to a third exemplary embodiment of the present invention is a modified example of the radio receiving apparatus 2. The radio receiving apparatus 3 differs from the radio receiving apparatus 2 in the mechanism for changing the directivity pattern of the antenna elements 10A and 10B.

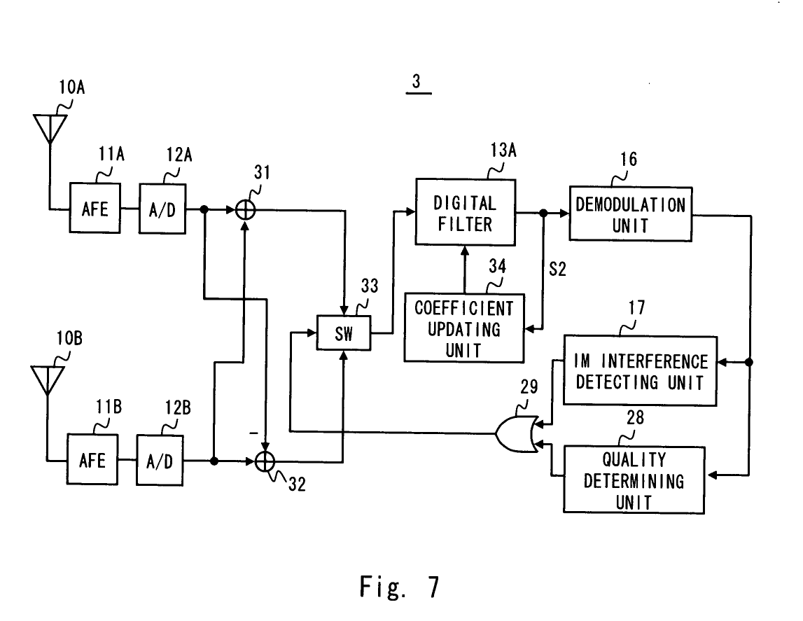

FIG. 7 is a block diagram showing a configuration example of the radio receiving apparatus 3. The radio receiving apparatus 3 shown in FIG. 7 differs from the radio receiving apparatus 2 shown in FIG. 5 in the following points. That is, the digital filter 13B is omitted in the radio receiving apparatus 3 shown in FIG. 7. Meanwhile, in the radio receiving apparatus 3 shown in FIG. 7, an adder 31, a subtractor 32, and a switch 33 are disposed at the previous stage of the digital filter 13A. A coefficient updating unit 34 adaptively updates the tap coefficients by using an output signal S2 of the digital filter 13A.

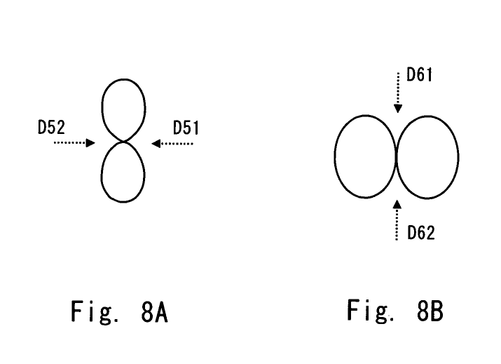

The adder 31 adds digital IF signals of two channels that are supplied from the A/D converters 12A and 12B. Meanwhile, the subtractor 32 performs subtraction of the digital IF signals of two channels that are supplied from the A/D converters 12A and 12B. In other words, the directivity pattern of the antenna elements 10A and 10B viewed from the output of the adder 31 is different from that viewed from the output of the subtractor 32. For example, when the distance between the antenna elements 10A and 10B is set as a half wavelength of the carried frequency of the radio signal, the directivity pattern viewed from the output of the adder 31 corresponds to a pattern shown in FIG. 8A. Meanwhile, the directivity pattern viewed from the output of the subtractor 32 corresponds to a pattern shown in FIG. 8B. Note that dotted arrows D51, D52, D61, and D62 shown in FIGS. 8A and 8B indicate null directions.

The switch 33 selectively supplies one of the output of the adder 31 and the output of the subtractor 32 to the digital filter 13A. In order to control the switch 33, control signals output from the IM interference detecting unit 17 and the quality determining unit 28 are input to the switch 33. In other words, the switch 33 is switched according to at least one of the conditions, namely, at least one of the detection of the occurrence of the IM interference by the IM interference detecting unit 17 and the detection of the degradation in quality of the demodulated signal by the quality determining unit 28. The switch 33 may alternately select the adder 31 and the subtractor 32 each time the control signal is received from the IM interference detecting unit 17 or the quality determining unit 28.

The radio receiving apparatuses 1 and 2 perform adaptive processing on the signals received by the antenna elements 10A and 10B and combine the signals, which enables adaptive control of the reception directivity, but increases costs. Meanwhile, in the radio receiving apparatus 3, one of the digital filters, namely, the digital filter 13B is omitted, and a composite signal which is obtained by combining signals in the adder 31 or the subtractor 32 and which has a directivity set in advance is input to the digital filter 13A. Thus, the radio receiving apparatus 3 can reduce costs compared to the radio receiving apparatuses 1 and 2. While FIG. 7 shows a configuration example for switching two directivity patterns, a configuration for switching three or more directivity patterns may be employed.

### Fourth Exemplary Embodiment

A radio receiving apparatus 4 according to a fourth exemplary embodiment of the present invention is another modified example of the radio receiving apparatus 2. The radio receiving apparatus 4 differs from the radio receiving apparatus 2 in the mechanism for switching the directivity pattern of the antenna elements 10A and 10B.

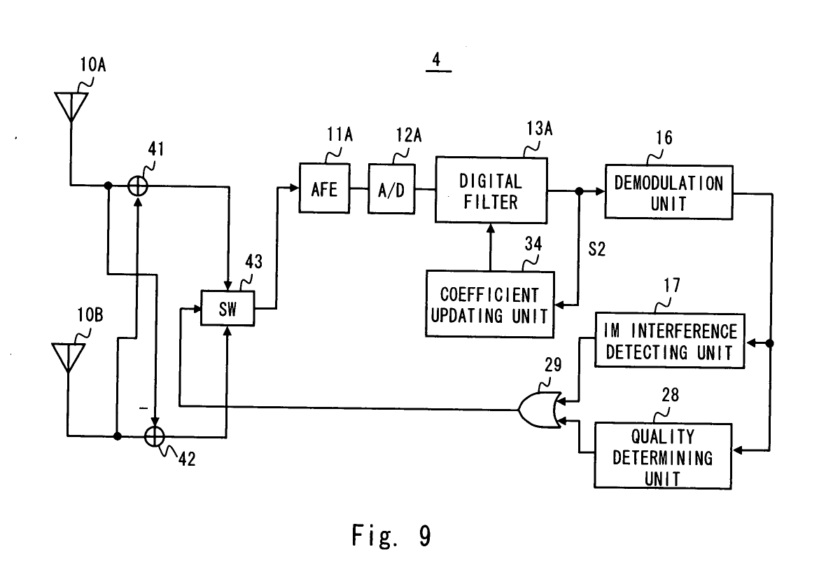

FIG. 9 is a block diagram showing a configuration example of the radio receiving apparatus 4. The radio receiving apparatus shown in FIG. 9 differs from the radio receiving apparatus 2 shown in FIG. 5 in the following points. That is, in the radio receiving apparatus 4 shown in FIG. 9, the AFE 11B, the A/D converter 12B, and the digital filter 13B are omitted. Meanwhile, in the radio receiving apparatus 4 shown in FIG. 9, an adder 41, a subtractor 42, and a switch 43 are disposed at the previous stage of the AFE 11A.

The adder 41 adds signals (analog RF signals) of two channels that are received by the antenna elements 10A and 10B. Meanwhile, the subtractor 42 performs subtraction of the received signals (analog RF signals) of two channels. In other words, the directivity pattern of the antenna elements 10A and 10B viewed from the output of the adder 41 is different from that viewed from the output of the subtractor 42, as in the case of the radio receiving apparatus 3 of the third exemplary embodiment.

The switch 43 selectively supplies one of the output of the adder 41 and the output of the subtractor 42 to the AFE 11A. In order to control the switch 43, control signals output from the IM interference detecting unit 17 and the quality determining unit 28 are input to the switch 43. In other words, the switch 43 is switched according to at least one of the conditions, namely, at least one of the detection of the occurrence of the IM interference by the IM interference detecting unit 17 and the detection of the degradation in quality of the demodulated signal by the quality determining unit 28. The switch 43 may operate so as to alternately select the adder 41 and the subtractor 42 each time the control signal is received from the IM interference detecting unit 17 or the quality determining unit 28.

In the radio receiving apparatus of this exemplary embodiment, the AFE 11B, the A/D converter 12B, and the digital filter 13B are omitted, and a composite signal which is obtained by combining signals in the adder 41 or the subtractor 42 and which has a directivity set in advance is input to the AFE 11A. Thus, the radio receiving apparatus 4 can reduce costs compared to the radio receiving apparatuses 1 to 3. While FIG. 9 shows a configuration example for switching two reception directivity patterns, a configuration for switching three or more reception directivity patterns may be employed.

### Fifth Exemplary Embodiment

A radio receiving apparatus 5 according to a fifth exemplary embodiment of the present invention is a modified example of the radio receiving apparatus 4. The principle of detecting the IM interference and the configuration for detecting the IM interference of the radio receiving apparatus 5 are different from those of the radio receiving apparatus 4.

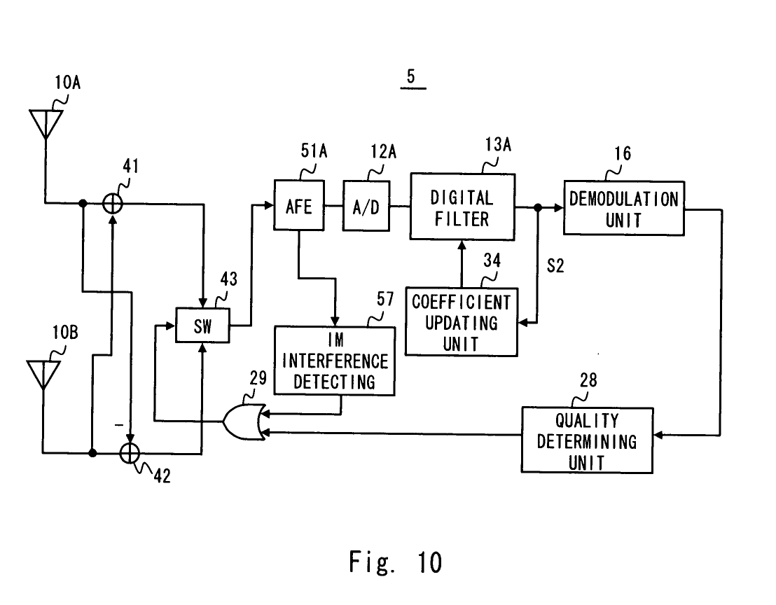

FIG. 10 is a block diagram showing the radio receiving apparatus 5. An IM interference detecting unit 57 detects the occurrence of the IF interference based on the analog IF signals of two channels that are supplied from an AFE 51A.

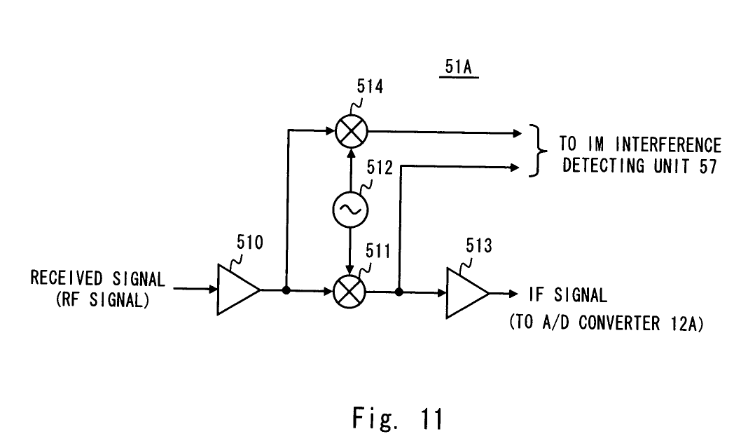

FIG. 11 shows a configuration example of the AFE 51A. An RF amplifier 510, a mixer 511, and an IF amplifier 513 are components for generating analog IF signals to be supplied to the A/D converter 12A. The mixer 511 multiples the analog RF signal amplified by the RF amplifier 510, by a local oscillation signal supplied from a local oscillator 512, to thereby convert the analog RF signal into an analog IF signal.

The AFE 51A shown in FIG. 11 includes a mixer 514 different from the mixer 511. Like the mixer 511, the mixer 514 converts an analog RF signal into an analog IF signal. However, the mixer 514 has such a distortion characteristic of easily causing intermodulation distortion in the output signal, compared to the mixer 511.

Because of the difference in distortion characteristic between the two mixers 511 and 514, signal powers of third-order intermodulation distortion components contained in the two analog IF signals, which are generated by the two mixers 511 and 514, are different. In other words, third-order intermodulation distortion greater than that of the output signal of the mixer 511 occurs in the output signal of the mixer 514 having a deteriorated distortion characteristic. Accordingly, the IM interference detecting unit 57 receives the analog IF signals of two channels that are generated by the mixers 511 and 514, and performs band-limiting processing on the two signals to measure a power difference. Then, when the power difference is larger than the predetermined reference value, the occurrence of the IM interference can be detected.

Note that in the first to fifth exemplary embodiments of the present invention, the configuration for receiving a radio signal using the two antenna elements 10A and 10B has been described. Alternatively, the radio receiving apparatuses 1 to 5 may be modified in such a manner that three or more reception antenna elements are disposed to adjust the reception directivity thereof by arithmetic processing on received signals of three or more channels.

Moreover, the components associated with digital signal processing, such as the digital filters 13A and 13B, the coefficient updating units 14 and 34, the demodulation unit 16, the IM interference detecting units 17 and 57, the quality determining unit 28, and the OR circuit 29, which are illustrated in the first to fifth exemplary embodiments of the present invention, may be implemented by a computer such as a DSP (Digital Signal Processor).

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A radio receiving apparatus comprising:
a detection unit that detects an occurrence of intermodulation interference to a desired signal demodulated based on received signals received by a plurality of antenna elements; and
a directivity changing unit that changes a reception directivity pattern of the plurality of antenna elements to another pattern having a null direction different from a null direction obtained before the directivity pattern is changed, in accordance with detection of the occurrence of the intermodulation interference by the detection unit.

2. The radio receiving apparatus according to claim 1, further comprising:
an analog signal processing unit that performs analog signal processing on the received signals or a composite signal of the received signals;
an A/D conversion unit that performs digital sampling of at least one analog signal generated by the analog signal processing;
an adaptive filter unit that adaptively performs filter processing on at least one digital signal obtained by the digital sampling; and
a demodulation unit that generates the desired signal by performing digital demodulation processing on at least one digital signal obtained by the filter processing.

3. The radio receiving apparatus according to claim 2, wherein
the adaptive filter unit comprises a plurality of digital filters respectively corresponding to the received signals, and a coefficient updating unit that updates tap coefficients of the plurality of digital filters in accordance with an adaptive algorithm,
the demodulation unit is disposed so as to perform digital demodulation processing on a signal obtained by combining output signals of the plurality of digital filters, and
the directivity changing unit changes the reception directivity pattern by performing exceptional updating of at least one of the tap coefficients of the plurality of digital filters, independently of the adaptive algorithm.

4. The radio receiving apparatus according to claim 3, wherein the reception directivity pattern is changed by changing at least one center tap position of the plurality of digital filters.

5. The radio receiving apparatus according to claim 2, wherein
the A/D conversion unit generates a plurality of digital signals respectively corresponding to the received signals,
the adaptive filter unit is disposed so as to perform filter processing on a signal obtained by combining the plurality of digital signals, and
the directivity changing unit changes the reception directivity pattern by changing a content of an operation for the plurality of digital signals when the plurality of digital signals are combined.

6. The radio receiving apparatus according to claim 2, wherein
the analog signal processing unit is disposed so as to perform analog signal processing on the composite signal, and
the directivity changing unit changes the reception directivity pattern by changing a content of an operation for the received signals in order to generate the composite signal.

7. The radio receiving apparatus according to claim 2, wherein the detection unit measures a modulation index of the desired signal from an output of the demodulation unit, and detects the occurrence of the intermodulation interference based on a magnitude of the modulation index.

8. The radio receiving apparatus according to claim 2, wherein
the analog signal processing unit is disposed so as to perform analog signal processing on the composite signal, and the analog signal processing unit comprises:
an amplification unit that amplifies the composite signal;
a first mixer that mixes the composite signal obtained after amplification with a local oscillation signal to generate a first intermediate frequency signal; and
a second mixer that has a distortion characteristic of easily causing intermodulation distortion in the received signals compared to the first mixer, the second mixer configured to mix the composite signal obtained after amplification with the local oscillation signal to generate a second intermediate frequency signal, and
the detection unit detects the occurrence of the intermodulation interference by comparing a signal amplitude of the first intermediate frequency signal with a signal amplitude of the second intermediate frequency signal.

9. The radio receiving apparatus according to claim 1, further comprising a quality determining unit that detects degradation in quality of the desired signal,
wherein the directivity changing unit changes the directivity pattern in accordance with detection of the occurrence of the intermodulation interference and the degradation in quality of the desired signal.

10. A radio receiving apparatus comprising:
an analog signal processing unit that performs analog signal processing on received signals received by a plurality of antenna elements;
an A/D conversion unit that generates digital signals by sampling the received signals subjected to the analog signal processing; and
a plurality of digital filters capable of adjusting amplitudes and phases of the digital signals;
a signal combining unit that generates a composite signal by combining the digital signals subjected to filter processing by the plurality of digital filters; and
a coefficient updating unit that updates tap coefficients of the plurality of digital filters, the tap coefficients determining a reception directivity pattern of the plurality of antenna elements,
wherein the coefficient updating unit updates the tap coefficients in accordance with an adaptive algorithm, and performs exceptional updating of at least one of the tap coefficients independently of the adaptive algorithm, in accordance with detection of an occurrence of intermodulation interference to a desired signal demodulated based on the composite signal.

11. The radio receiving apparatus according to claim 10, wherein the exceptional updating is performed so that a null direction included in the reception directivity pattern of the plurality of antenna elements is formed in a different direction from a null direction of a directivity pattern obtained before the updating.

12. The radio receiving apparatus according to claim 11, wherein the exceptional updating is performed by changing at least one center tap position of the plurality of digital filters.

13. A radio receiving method comprising:
detecting an occurrence of intermodulation interference to a desired signal demodulated from a composite signal of received signals received by a plurality of antenna elements, or from one received signal included in the received signals; and
changing a reception directivity pattern of the plurality of antenna elements to another pattern having a null direction in a direction different from a null direction obtained before the directivity pattern is changed, in accordance with detection of the occurrence of the intermodulation interference.

14. The radio receiving method according to claim 13, wherein the occurrence of the intermodulation interference is detected based on a magnitude of a modulation index of the desired signal.
